(19) United States
(12) Patent Application Publication
(10) Pub. No.: US 2023/0011787 A1
(43) Pub. Date: Jan. 12, 2023

(54) ADJUSTABLE KNIFE GUIDE ASSEMBLY

(71) Applicant: William David Penniman, Columbus, OH (US)

(72) Inventor: William David Penniman, Columbus, OH (US)

(21) Appl. No.: 17/649,687

(22) Filed: Feb. 2, 2022

Related U.S. Application Data
(60) Provisional application No. 63/219,078, filed on Jul. 7, 2021.

(51) Int. Cl. B26B 29/06

(52) U.S. Cl. CPC B26B 29/063; B26B 2029/066

(57) ABSTRACT

The invention disclosed herein facilitates consistent slicing into equal halves or other special thicknesses of bagels and other bread products, while simultaneously protecting both hands from harm. The present invention is also fully adjustable to accommodate various size bread products. To achieve these functionalities, adjustable guides are provided that extend above the bread product to be cut to guide the knife from initial cut all the way to the end of the cut. Further, the present invention easily disassembles for cleaning.

### CROSS-REFERENCE TO RELATED APPLICATION

This application claims the benefit of priority of U.S. provisional application No. 63/219,078, filed Jul. 7, 2021, the contents of which are herein incorporated by reference.

### BACKGROUND OF THE INVENTION

The present invention relates to bread product slicers and, more particularly, to an apparatus and method for slicing bagels or other shaped bread products in equal halves while protecting both hands of the user.

Bagel slicing is one of the top five dangerous kitchen activities. As of 2021, there were approximately 2000 visits per year to U.S. emergency rooms involving bagel slicing accidents. Many bagels, when about to be cut, are either frozen, at least partially stale, and/or are being cut with a dull knife. These, and other factors, contribute to injuries that necessitate the trip to the emergency room.

There are various problems with the prior art solutions. By way of example, guillotine slicers can crush bagels. Further, knife guides are often too low to start the knife safely. The majority are one-size only, meaning they cannot be customized to various size products being cut. Most knife slicers do not require both hands to be safely occupied.

As can be seen, there is a need for a safe apparatus and method for cutting bagels and the like. The present invention is advantageously fully adjustable for various sizes. A blade guide of the apparatus extends above the top of bagel to guide the knife from initial cut, and both hands of the user are safely occupied. Further, embodiments of the present invention easily disassemble for cleaning.

### SUMMARY OF THE INVENTION

In one aspect of the present invention, a knife guide for bread products is disclosed, and the knife guide includes: a substantially planar fixed base board; a fixed back board coupled to or integral with the fixed base board and extending substantially perpendicularly therefrom; a base guide member coupled to or integral with the fixed base board and extending substantially perpendicularly therefrom; a horizontally sliding unit comprising: a slide base board configured to slide along the fixed base board; a slide back board coupled to or integral with the slide base board, the slide back board being configured to slide along the fixed back board; and a slide guide member coupled to or integral with the slide base board such that a spacing between the slide guide member the base guide member is adjustable; and a handle coupled to the sliding unit for moving the sliding unit.

These and other features, aspects and advantages of the present invention will become better understood with reference to the following drawings, description, and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a perspective view of an embodiment of the present invention, shown in use;

FIG. 2 is a perspective view of the embodiment of the present invention;

FIG. 3 is an exploded view of the embodiment of the present invention;

FIG. 4 is a top view of the embodiment of the present invention;

FIG. 5 is a front view of the embodiment of the present invention; and

FIG. 6 is a section view of the embodiment of the present invention, taken along line 6-6 from FIG. 5.

### DETAILED DESCRIPTION OF THE INVENTION

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details. For the purpose of clarity, technical material that is known in the technical fields related to the present invention has not been described in detail so that the present invention is not unnecessarily obscured

Broadly, one embodiment of the present invention is an adjustable knife guide for bread products. As stated above, bagel slicing is one of the most dangerous kitchen activities, with it contributing to 2000 visits in the U.S. per year to emergency rooms. The invention claimed here solves this problem. The device of the present invention occupies both hands away from the sharp knife edge and centers the bagel (or other object) to slice it in equal halves and is adjustable for various size bagels or other objects. Unlike the aforementioned guillotine slicers, this does not crush the bagel. Unlike other holders for knife slicing, this device is fully adjustable to accept various shapes and sizes. It has a handle on one side requiring both hands to be occupied. The blade guides extend above the top of the bagel to guide the knife from initial cut. In addition to residential use, embodiments of the present invention may be appropriate for commercial use, such as in bagel shops and other restaurants where bagels are routinely sliced.

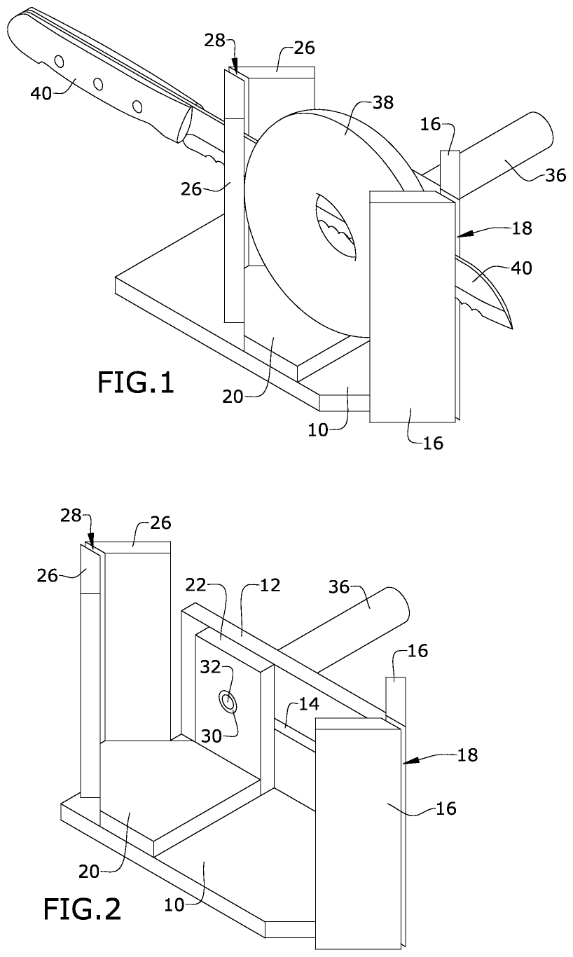

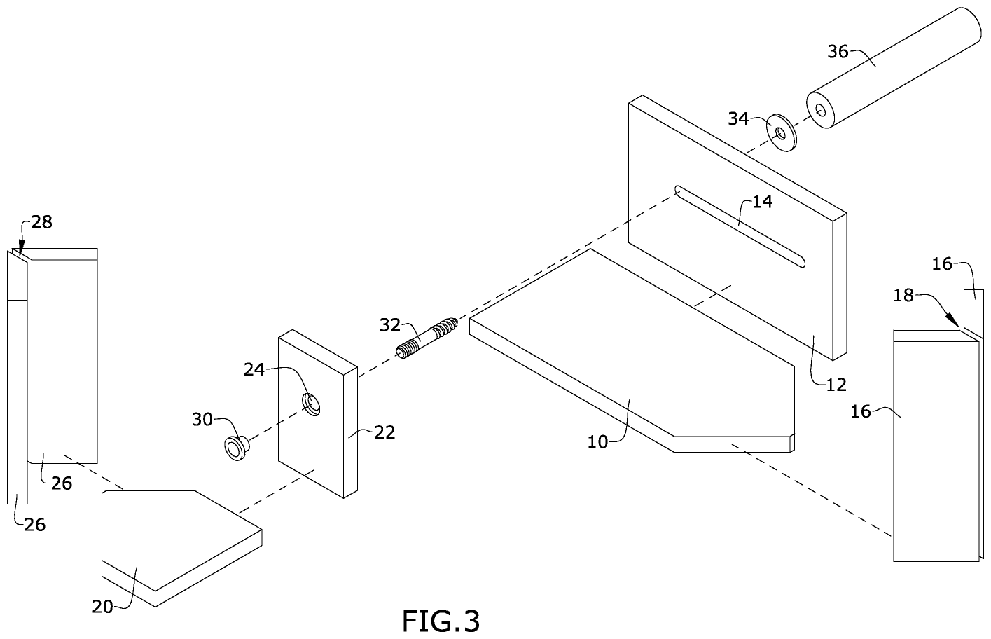

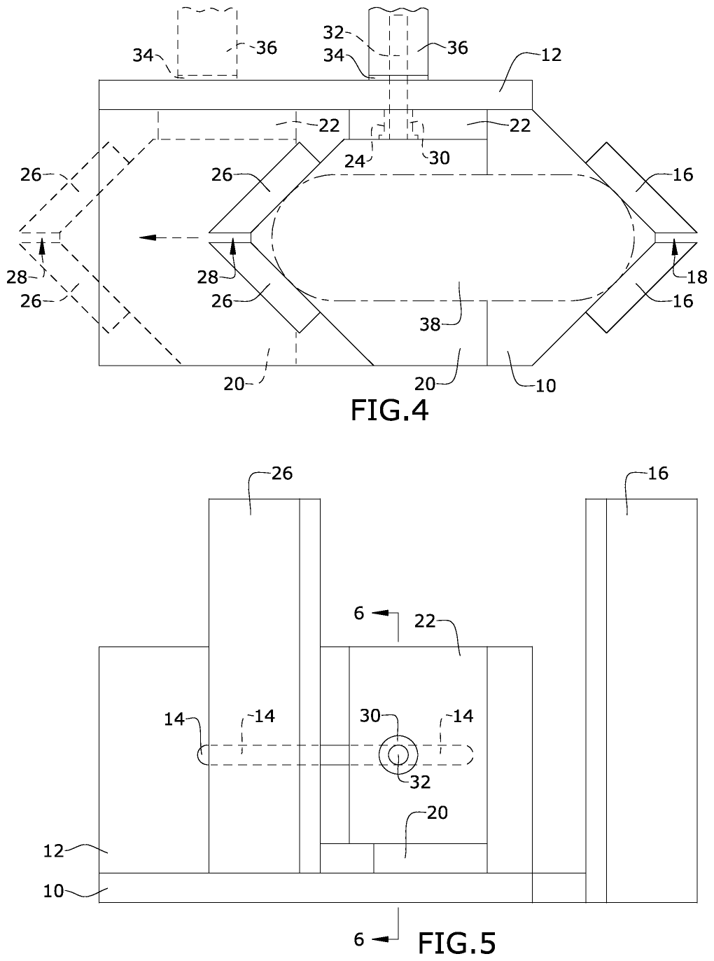

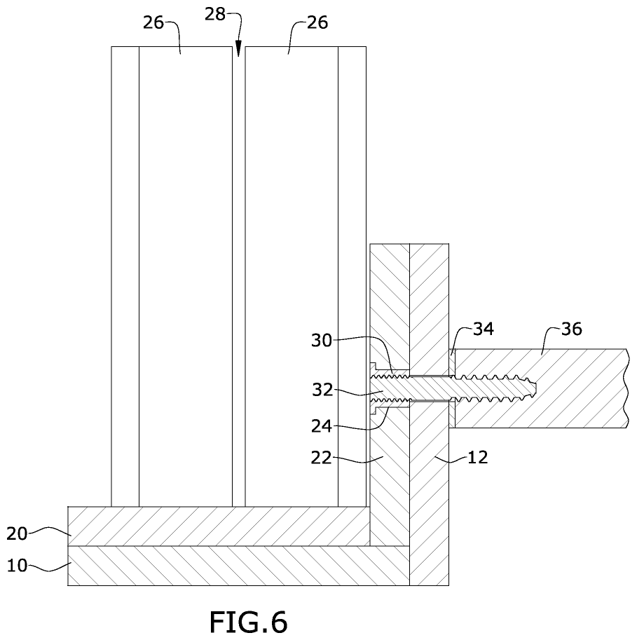

Referring now to FIG. 1, a knife guide includes, in general, a base board 10, a back board 12, a base guide member 16, a slide base board 20, a slide back board 22, a slide guide member 26, and a handle 36. The back board 12 is coupled to or integral with the base board 10 and extends substantially perpendicularly therefrom. The base guide board 16 is coupled to or integral with the base board 10 and extends substantially perpendicularly therefrom. The base guide member 16, as shown in FIGS. 2 and 3, may be arranged on the base board 10 substantially perpendicularly relative thereto. The slide guide member 26 is coupled or integral with an outer portion of the slide base board 20. The slide back board 22 is coupled to or integral with the slide base board 20 and extends substantially perpendicularly therefrom, forming a sliding unit (also referred to as a “sled”). As demonstrated in FIG. 4, the sliding unit is configured to slide along a length of the base board 10 such that a spacing of the slide guide member 26 and the base guide member 16 can be adjusted.

As shown in FIG. 2, both the base guide member 16 and the slide guide member 26 may be formed as a pair of panels arranged in a substantially V-shape (when viewed from the top, as in FIG. 4). The base guide board member 16 has a base guide slot 18 defined between the panels, and the slide guide member 26 has a slide guide slot 28 defined between the panels. While singular slots 18, 28 are shown on each guide member 16, 26, it will be appreciated by those with skill in the art that additional slots may be formed on lateral sides of the centrally located slots 18, 28. These additional slots may be used to cut a bagel (or other bread product) into thinner sections, as desired by a user of the present invention.

Making reference to FIG. 3, a sliding slot 14 is defined in the back board 12 to permit operable coupling of the handle 36 and the slide back board 22. In exemplary embodiments, the handle 36 and the slide back board 22 may be coupled together in the following manner. The slide back board 22 may have a opening 24 defined therewithin, in which a T-nut fastener is coupled. The handle 36 may include a threaded opening defined therewithin, and a washer 34 interposed between the handle 36 and the back board 12. A hanger bolt 32 is then threadably coupled at opposite ends to the T-nut and the threaded opening in the handle 36. Those with skill in the art will appreciate that the coupling between the handle 36 and the slide back board 22 may be embodied in any appropriate way. The threaded coupling, among other things, allows the assembly to be broken down into its separate components such that they may be cleaned.

In use, a bagel 38 (or other product) is placed in the knife guide. The sliding unit (as characterized above) is slidable on the base board 10 to adjust a spacing between the base guide member 16 and the slide guide member 26. This is, in particular, advantageous because it allowed the knife guide to adjust to different product sizes that are to be cut. The screwable coupling of the handle 36 allows a user to loosen it when the sliding unit needs adjusting (such that the hanger bolt 32 slides in the sliding slot 14. The user can simply twist the handle clockwise to retighten it and secure the sliding unit in place for cutting use. Further, the V-shape that the members 16, 26 take allows for a product 38 to be centered for cutting. As shown in FIG. 1, the slots 18, 28 are coaxially aligned such that a knife 40 can cut down through the product. As the members 16, 26 extend far vertically upward, the blade of the knife 40 will always be disposed within the slots 18, 28 when cutting actually occurs, giving the user better control of the knife 40 and reducing the likelihood of injury. When cutting, the handle 36 can be grasped to maintain the knife guide in place. Thus, both hands are occupied in locations safe from being cut (i.e., one on the knife 40, the other on the handle 36 which is safely away from where the blade cuts).

In certain embodiments, the present invention may be formed substantially from wood and finished with food quality tung or mineral oil. In preferred embodiments, the primary structural components may be formed from plastic via injection molding. However, those with skill in the art will appreciate that other appropriate materials and processes for forming the knife guide are contemplated and within the spirit and scope of the present disclosure. In addition, other slotted guides may be added to members 16 and 26 to allow items to be sliced into smaller sections than halves, as described above.

While one or more preferred embodiments are disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

While apparatuses and methods are described in terms of “comprising,” “containing,” or “including” various components or steps, the apparatuses and methods can also “consist essentially of” or “consist of” the various components and steps. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted. Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A knife guide for bread products, the knife guide comprising:
a substantially planar fixed base board;
a fixed back board coupled to or integral with the fixed base board and extending substantially perpendicularly therefrom;
a base guide member coupled to or integral with the fixed base board and extending substantially perpendicularly therefrom;
a horizontally sliding unit comprising:
a slide base board configured to slide along the fixed base board;
a slide back board coupled to or integral with the slide base board, the slide back board being configured to slide along the fixed back board; and
a slide guide member coupled to or integral with the slide base board such that a spacing between the slide guide member the base guide member is adjustable; and
a handle coupled to the sliding unit for moving the sliding unit.

2. The knife guide of claim 1, wherein the base guide member comprises a pair of panels that define a slot therebetween.

3. The knife guide of claim 2, wherein the slide guide member comprises a pair of panels that define a slot therebetween.

4. The knife guide of claim 3, wherein the fixed back board defines a sliding slot, with the handle being coupled to the slide back board through the sliding slot.

5. The knife guide of claim 4, wherein the handle is rotatable to selectively lock and unlock the slide back board with the fixed back board.

6. The knife guide of claim 5, wherein the handle is removably coupled to the slide back board.

7. The knife guide of claim 6, wherein the sliding unit is removable from the fixed base board and the fixed back board when the handle is uncoupled from the slide back board.

8. The knife guide of claim 7, wherein the base guide member defines a substantially V-shaped profile.

9. The knife guide of claim 8, wherein the base guide member defines a substantially V-shaped profile.

10. The knife guide of claim 9, wherein the slot of the slide guide member and the slot of the base guide member are coaxially aligned.
